(19) United States
(12) Patent Application Publication
(10) Pub. No.: US 2016/0154564 A1
(43) Pub. Date: Jun. 2, 2016

(54) ELECTRONIC DEVICE AND METHOD FOR PROVIDING DESKTOP USER INTERFACE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-SAN CHIANG, New Taipei (TW); NAN YU, Shenzhen (CN); HUA-DONG CHENG, Shenzhen (CN); LING-JUAN JIANG, Shenzhen (CN)

(21) Appl. No.: 14/750,414

(22) Filed: Jun. 25, 2015

(30) Foreign Application Priority Data
Dec. 1, 2014 (CN) 201410717987.9

(51) Int. Cl. G06F 3/0481; G06F 3/0488; G06F 3/0484; G06F 3/0482

(52) U.S. Cl. CPC G06F 3/04817; G06F 3/0482; G06F 3/0488; G06F 3/04847

(57) ABSTRACT

In a user interface providing method, a spherical desktop interface is generated. The spherical desktop interface includes a number of interface areas. Class icons of application program are displayed on a third interface area. A currently selected class icon is displayed on a second interface area. And application icons associated with the currently selected class icon is displayed on a first interface area

### CROSS-REFERENCE TO RELATED APPLICATIONS

This application claims priority to Chinese Patent Application No. 201410717987.9 filed on Dec. 1, 2014, the contents of which are incorporated by reference herein.

### FIELD

The subject matter herein generally relates to graphic user interfaces (GUI), and more specifically relates to an electronic device and a method for providing a desktop user interface.

### BACKGROUND

Software applications may be run on a computing device. Typically, a GUI including the application icons is provided for allowing a user to interact with the applications.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a desktop user interface providing system and functional modules of the desktop user interface providing system.

FIG. 2 is a flowchart of one embodiment of a method for providing a desktop user interface.

FIG. 3 is a diagrammatic view of one embodiment of a desktop interface.

FIG. 4 is a diagrammatic view of the desktop interface in FIG. 3, which includes application icons.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

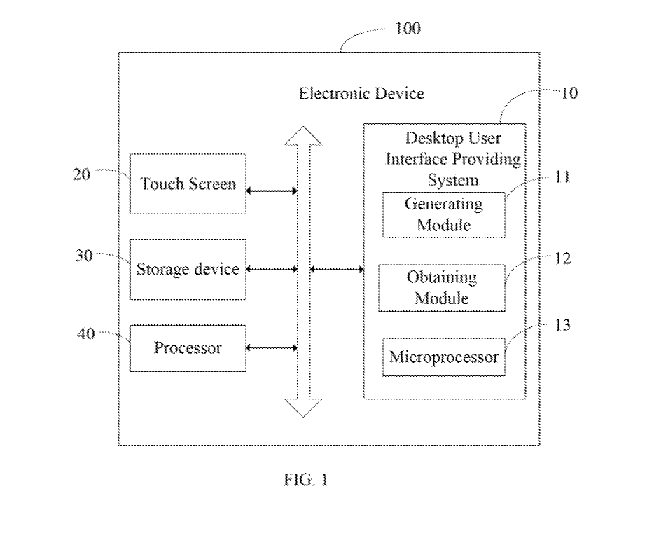

FIG. 1 is a block diagram of one embodiment of a hardware environment for executing a desktop user interface providing system. The desktop user interface providing system 10 is installed and runs in an apparatus, for example an electronic device 100. In at least one embodiment as shown in FIG. 1, the electronic device 100 includes, but is not limited to, a touch screen 20, a storage device 30, and at least one processor 40. The electronic device 100 can be a tablet computer, a notebook computer, a smart phone, a personal digital assistant (PDA), or other suitable electronic device. FIG. 1 illustrates only one example of the electronic device 100 and can include more or fewer components than illustrated, or have a different configuration of the various components in other embodiments.

The desktop user interface providing system 10 can provide a spherical desktop user interface, and classify display icons of application programs on the spherical desktop user interface.

In one embodiment, the storage device 30 can include various types of non-transitory computer-readable storage mediums. For example, the storage device 30 can be an internal storage system, such as a flash memory, a random access memory (RAM) for temporary storage of information, and/or a read-only memory (ROM) for permanent storage of program code or data of the desktop user interface system 10. The storage device 30 can also be an external storage system, such as a hard disk, a storage card, or a data storage medium. The at least one processor 40 can be a central processing unit (CPU), a microprocessor, or other data processor chip that performs functions of the desktop user interface system 10 in the electronic device 100. The touch screen 20 can sense touch operations applied on the touch screen 20.

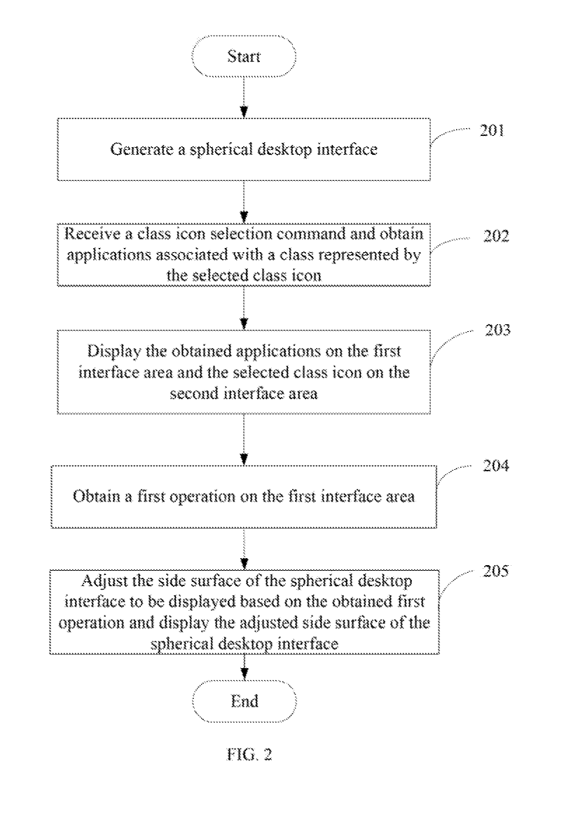

FIG. 1 also illustrates a block diagram of one embodiment of the function modules of the desktop user interface providing system 10. In at least one embodiment, the desktop user interface providing system 10 can include a generating module 11, an obtaining module 12, and microprocessor 13. The function modules 11-13 can include computerized codes in the form of one or more programs, which are stored in the storage device 30, and executed by the at least one processor 40 of the electronic device 10. A detailed description of the functions of the modules 11-13 is given below in reference to FIG. 2.

FIG. 2 illustrates a flowchart of one embodiment of a method for providing a desktop user interface. The example method 200 is provided by way of example, as there are a variety of ways to carry out the method. The method 200 described below can be carried out using the configurations illustrated in FIGS. 1 and 2, for example, and various elements of these figures are referenced in explaining example method 200. Each block shown in FIG. 2 represents one or more processes, methods or subroutines, carried out in the exemplary method 200. Additionally, the illustrated order of blocks is by example only and the order of the blocks can change according to the present disclosure. The exemplary method 200 can begin at block 201. Depending on the embodiment, additional steps can be added, others removed, and the ordering of the steps can be changed.

At block 201, the generating module generates a spherical desktop interface.

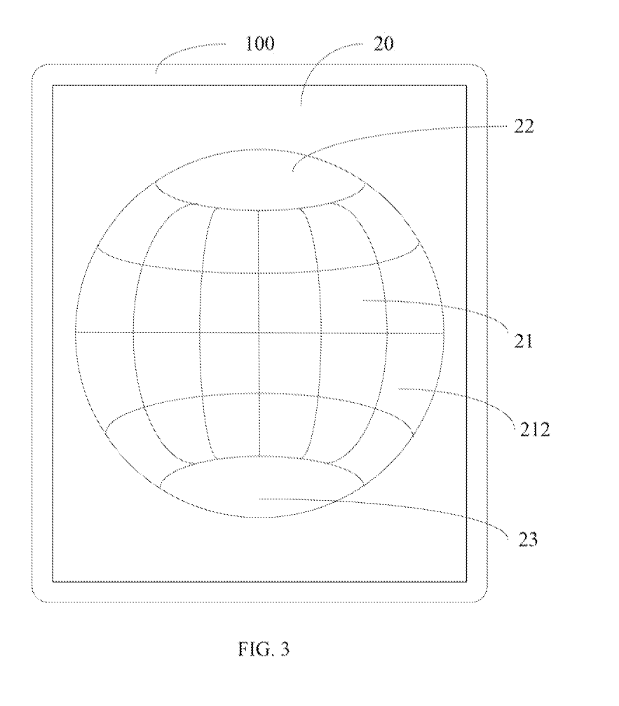

FIG. 3 shows the spherical desktop interface in accordance with an embodiment. The spherical desktop interface includes a first interface area 21, a second interface area 22, and a third interface area 23. In the embodiment, the second interface area 22 and the third interface area 23 are respectively located on two tapered ends of the spherical desktop interface. In the embodiment, the second interface area 22 is located on the top tapered end of the spherical desktop interface; the third interface area 23 is located on the bottom tapered end of the spherical desktop interface. The first interface area 21 is located between the second interface area 22 and the third interface area 23.

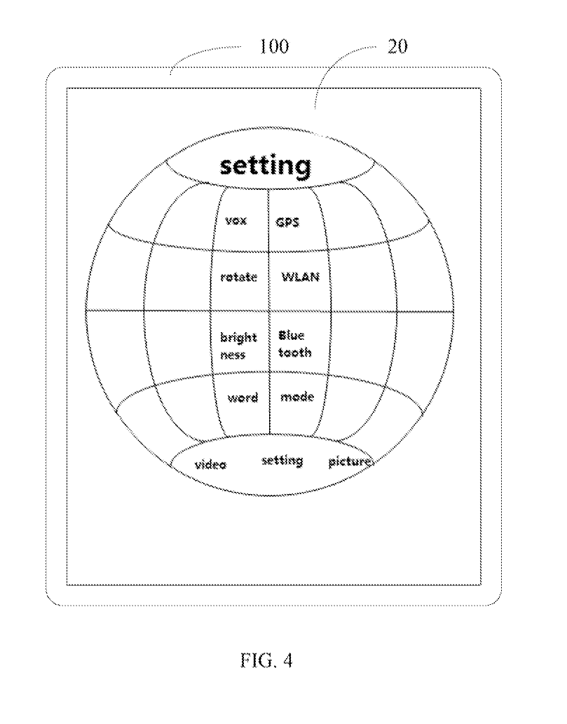

FIG. 4 is a diagrammatic view of the desktop interface in FIG. 3, which includes application icons. In the embodiment, class icons are displayed in the third interface area 23. Each class icon is representing a signal class of applications installed on the electronic device 100. A currently selected class icon is displayed in the second interface area 22. Icons of all applications, which belong to a signal class represented by the class icon in the second interface area 22, are displayed in the first interface area 21. The first interface area 21 comprising a number of sub-interface segments 212. Each of application icons is displayed in one of the sub-interface segments 212 of the first interface area 21.

At block 202, the obtaining module receives a class icon selection request and obtains applications associated with a class represented by the selected class icon.

In an embodiment, the storage device 30 stores application icons and class icons. The application icons are associated with the application programs installed on the electronic device 100. Each class icon represents one class of application programs. In an alternative embodiment, the storage device 30 further stores the number of the application programs which belongs to a signal class, a display order of the application programs, or the like.

In the embodiment, the obtaining module 12 determines the class icon selected by a user according to operations on the spherical desktop interface. In an embodiment, the user applies an operation on the second interface area 22 (herein after “a second operation”); the obtaining module 12 determines the selected class icon based on the second operation. The second operation can be an operation selected from the group consisting of a left sliding operation, a right sliding operation, an upward sliding operation, a downward sliding operation, a clockwise sliding operation and a counter-clockwise sliding operation. For example, the obtaining module 12 determines a class icon backward next to the currently selected class icon is selected by the user when the user applies a right sliding operation on the second interface area 22, and a class icon forward next to the currently selected class icon is selected by the user when the user applies a left sliding operation on the second interface area 22.

In other embodiments, the user applies an operation on the third interface area 23 (herein after “a third operation”); the obtaining module 12 determines the selected class icon based on the third operation. The third operation can be an operation selected from the group consisting of a left sliding operation, a right sliding operation, an upward sliding operation, a downward sliding operation, a clockwise sliding operation, a counter-clockwise sliding operation, a click operation, a double click operation and a long press operation. For example, the obtaining module 12 determines a class icon backward next to the currently selected class icon is selected by the user when the user applies a right sliding operation on the third interface area 23, and a class icon forward next to the currently selected class icon is selected by the user when the user applies a left sliding operation on the third interface area 23. The obtaining module 12 determines a class icon corresponding with the place of the click operation, the double click operation or the long press operation on the third interface area 23.

At block 203, the microprocessor displays the obtained applications on the first interface area, and displays the selected class icon on the second interface area.

In an embodiment, the microprocessor 13 displays the class icons on the third interface area 23, including all class icons or part class icons. In the embodiment, the microprocessor 13 displays at least the current selected class icon; a class icon forward next to the selected class icon and a class icon backward next to the selected class icon on the third interface area 23.

At block 24, the obtaining module obtains a first operation on the first interface area.

At block 25, the microprocessor adjusts the side surface of the spherical desktop interface to be displayed based on the obtained first operation and displays the adjusted side surface of the spherical desktop interface.

In the embodiment, the microprocessor 13 only adjusts the side surface of the first interface area to be displayed based on the first operation and displays the adjusted side surface of the first interface area.

The storage device 30 stores a sheet recording relationships between slide operations and rotation of the spherical desktop interface, including relationships between the slide direction and the rotation direction, and relationships between the slide distance and the rotation angle. The microprocessor 13 determines a rotation direction based on the slide direction of a slide operation and determines a rotation angle based on the slide distance of the slide operation. The microprocessor 13 further controls the displayed side surface of spherical desktop interface to rotate the rotation angle in the rotation direction, then application icons displayed on the other side surfaces of the spherical desktop interface can be shown to users.

In one embodiment, the microprocessor 13 makes application icons located on the adjusted side surface vibrate up or down according to a predefined order such as, the icons located in the top position are vibrated first, then the middle position, and the last the bottom position.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device comprising:
a touch screen;
a processor coupled to the touch screen; and
a storage device coupled to the processor, the storage device storing one or more programs, application icons associated with the one or more programs, and class icons representing classes of the programs, the one or more programs which, when executed by the at least one processor, cause the at least one processor to:
generate a spherical desktop interface displayed on the touch screen; and
displaying application icons on the spherical desktop interface according to the classes of the programs.

2. The electronic device according to claim 1, wherein the spherical desktop interface comprising a first interface area, a second interface area, and a third interface area; the class icons are displayed on the third interface area, a currently selected class icon is displayed on the second first interface area, and application icons associated with the currently selected icon is displayed on the first interface area.

3. The electronic device according to claim 2, wherein the first interface area comprises more than one sub-interface areas, each of application icons is displayed in one sub-interface area.

4. The electronic device according to claim 3, further comprising:
receiving a class icon selection request;
obtaining applications which belong to a class represented by the selected class icon; and
displaying the obtained applications on the sub-interface areas and the selected class icon on the second interface area.

5. The electronic device according to claim 4, wherein the class icon selection request is generated when a second operation is applied on the second interface area, and the selected class icon is determines based on the second operation.

6. The electronic device according to claim 4, wherein the class icon selection request is generated when a third operation is applied on the third interface area, and the selected class icon is determines based on the third operation.

7. The electronic device according to claim 4, further comprising:
obtaining a first operation on the first interface area;
adjusting the side surface of the spherical desktop interface to be displayed based on the obtained first operation; and
displaying the adjusted side surface of the spherical desktop interface.

8. The electronic device according to claim 4, wherein the second interface area and the third interface area are located on two tapered ends of the spherical desktop interface, the first interface area is located between the second interface area and the third interface area.

9. A method for providing a user interface executable by at least one processor of an electronic device, the method comprising:
generating a spherical desktop interface; and
displaying application icons on the spherical desktop interface according to the classes of the programs, wherein the application icons are associated with programs installed on the electronic device.

10. The method according to claim 9, wherein the spherical desktop interface comprising a first interface area, a second interface area, and a third interface area; class icons are displayed on the third interface area, the class icons are representing classes of the installed programs, a currently selected class icon is displayed on the second interface area, and application icons associated with the currently selected class icon is displayed on the first interface area.

11. The method according to claim 10, further comprising:
receiving a class icon selection request;
obtaining applications which belong to a class represented by the selected class icon; and
displaying the obtained applications on the sub-interface areas and the selected class icon on the second interface area.

12. The method according to claim 11, further comprising:
obtaining a first operation on the first interface area;
adjusting the side surface of the spherical desktop interface to be displayed based on the obtained first operation; and
displaying the adjusted side surface of the spherical desktop interface.

13. The method according to claim 11, wherein the class icon selection request is generated when a second operation is applied on the second interface area, and the selected class icon is determines based on the second operation.

14. The method according to claim 11, the class icon selection request is generated when a third operation is applied on the third interface area, and the selected class icon is determines based on the third operation.

15. A non-transitory storage medium having stored thereon instructions that, when executed by a processor of an electronic device, causes the processor to provide a user interface, wherein the method comprises:
generating a spherical desktop interface; and
displaying application icons on the spherical desktop interface according to the classes of the programs, wherein the application icons are associated with programs installed on the electronic device.

16. The non-transitory storage medium according to claim 15, wherein the spherical desktop interface comprising a first interface area, a second interface area, and a third interface area; class icons are displayed on the third interface area, the class icons are representing classes of the installed programs, a currently selected class icon is displayed on the second first interface area, and application icons associated with the currently selected icon is displayed on the first interface area.

17. The non-transitory storage medium according to claim 16, further comprising:
receiving a class icon selection request;
obtaining applications which belong to a class represented by the selected class icon; and
displaying the obtained applications on the sub-interface areas and the selected class icon on the second interface area.

18. The non-transitory storage medium according to claim 17, further comprising:
obtaining a first operation on the first interface area;
adjusting the side surface of the spherical desktop interface to be displayed based on the obtained first operation; and
displaying the adjusted side surface of the spherical desktop interface.

19. The non-transitory storage medium according to claim 17, wherein the class icon selection request is generated when a second operation is applied on the second interface area, and the selected class icon is determines based on the second operation.

20. The non-transitory storage medium according to claim 19, wherein the second operation is a element selected from the group consisting of a left sliding operation, a right sliding operation, an upward sliding operation, a downward sliding operation, a clockwise sliding operation and a counter-clockwise sliding operation.
